(19) United States
(12) Patent Application Publication
(10) Pub. No.: US 2023/0211252 A1
(43) Pub. Date: Jul. 6, 2023

(54) KIT FOR CONSTRUCTING CRAFT USING PLURALITY OF BLOCKS AND STORAGE CONTAINER FOR SAME

(71) Applicant: Spin Master Ltd., Toronto (CA)

(72) Inventors: Annalee ROBBINS, Toronto (CA); Matthew LENTINI, Toronto (CA); Katherine PRYSZLAK, Toronto (CA); Scott LUTZ, Toronto (CA)

(21) Appl. No.: 17/936,617

(22) Filed: Sep. 29, 2022

Related U.S. Application Data
(60) Provisional application No. 63/266,428, filed on Jan. 5, 2022.

(51) Int. Cl. A63H 33/10; B65D 81/36; B65D 25/04

(52) U.S. Cl. CPC A63H 33/10; B65D 81/36; B65D 25/04

(57) ABSTRACT

In an aspect, a kit is provided for constructing a craft from a plurality of blocks. Each block has an exterior surface that is made from a material that is adherent when exposed to water so as to permit the blocks to adhere to one another. A block tray supports the plurality of blocks. The kit includes a water dispenser for dispensing water and a storage container. The storage container includes a lower housing member that contains at least one block storage compartment for holding the blocks, and a cover to mount at least indirectly to the lower housing member. The cover is openable, and is sized to fit over the block tray while the block tray holds the blocks. The cover further includes an opening that is sized to permit, during use, a user to dispense water onto the plurality of blocks on the block tray.

### CROSS-REFERENCE TO RELATED APPLICATIONS

This application claims the benefit of U.S. Provisional Application No. 63/266,428, filed Jan. 5, 2022, the contents of which are incorporated herein by reference in their entirety.

### FIELD OF THE DISCLOSURE

The present invention relates generally to blocks for constructing crafts, and more particularly to storage containers therefor.

### BACKGROUND OF THE DISCLOSURE

Kits have been provided in the past, containing a plurality of beads that were made of a material that, when exposed to water, became adherent to one another. Some kits were difficult to use because the beads where spherical and did not therefore have large areas of contact with one another. Some kits were messy to use as the user inadvertently sprayed water other than on the beads, or some of the dissolved bead material would wind up on the table that the user worked at.

It would be advantageous to provide a kit for producing a craft that addresses one or more of the problems identified above or other problems that are present with some kits.

### SUMMARY OF THE DISCLOSURE

In an aspect, a kit is provided for constructing a craft from a plurality of blocks and a block tray. Each block has a main body having an exterior surface that is made from a material that is adherent when exposed to water so as to permit a first block from the plurality of blocks to be adherable to a second block of the plurality of blocks by applying water to at least one of the first and second blocks. The block tray is shaped to support the plurality of blocks. The kit includes a water dispenser for dispensing water and a storage container. The storage container includes a lower housing member that contains at least one block storage compartment for holding the plurality of blocks, and a cover that is sized to mount at least indirectly to the lower housing member to form an enclosed storage container interior therewith. The cover is openable to permit access to the storage container interior, and is sized to fit over the block tray while the block tray holds the plurality of blocks. The cover further includes an opening that is sized to permit, during use, a user to dispense water onto the plurality of blocks on the block tray.

In another aspect, a kit is provided for constructing a craft from a plurality of blocks. Each block has a main body having an exterior surface that is made from a material that is adherent when exposed to water so as to permit a first block from the plurality of blocks to be adherable to a second block of the plurality of blocks by applying water to at least one of the first and second blocks. Each block has a minimum dimension and a maximum dimension that is larger than the minimum dimension. The storage container includes a lower housing member that contains a plurality of block storage compartments for holding the plurality of blocks, wherein the block storage compartments are defined by a plurality of block storage compartment walls which have an upper edge. The storage container further includes a divider that is positioned such that a gap between the upper edge of the block storage compartment walls and an underside of the divider is smaller than the maximum dimension of each of the plurality of blocks so as to at least inhibit spillage and mixing of any blocks from the plurality of blocks stored in any one of the plurality of block storage compartments with any blocks from the plurality of blocks stored in any other one of the plurality of block storage compartments. The divider has an upper surface that is a floor of a secondary storage compartment for the storage container. The storage container further includes a cover that is sized to mount at least indirectly to the lower housing member to form an enclosed storage container interior therewith. The cover is cover is openable to permit access to the storage container interior, and is sized to fit over the block tray while the block tray holds the plurality of blocks. The cover encloses the secondary storage compartment when connected at least indirectly to the lower housing member.

### BRIEF DESCRIPTION OF THE DRAWINGS

Embodiments will now be described, by way of example only, with reference to the attached figures, as follows:

FIG. 1 is a perspective view of a block for use in producing a craft in accordance with an embodiment of the present disclosure.

FIG. 2 is another perspective view of the block shown in FIG. 1.

FIG. 3 is a sectional perspective view of the block shown in FIG. 1.

FIG. 4 is a perspective view of a block tray that can be used with the block shown in FIG. 1.

FIG. 5 is a perspective view of one block tray projection from among a plurality of block tray projections that are present on the block tray shown in FIG. 4.

FIG. 6 is a sectional elevation view a portion of the block tray shown in FIG. 4 with the block shown in FIG. 1 thereon.

FIG. 7A is a sectional plan view of the block on the block tray shown in FIG. 6, at a first elevation.

FIG. 7B is another sectional plan view of the block on the block tray shown in FIG. 6, at a second elevation.

FIG. 8 is a perspective view of a kit that includes a plurality of the block shown in FIG. 1.

FIG. 9 is a perspective view of a plurality of the blocks from the kit shown in FIG. 8, with water applied thereto, being adhered together.

FIG. 10 is an elevation view of two blocks from the kit shown in FIG. 8, stacked on top of one another, with water applied thereto, being adhered together.

FIG. 11 is a perspective view of a kit that includes a storage container, a water dispenser and a plurality of secondary tools, in accordance with another embodiment of the present disclosure.

FIG. 12 is an exploded view of the storage container shown in FIG. 11.

FIG. 13 is a sectional perspective view of a cover from the storage container shown in FIG. 11, being used with the water dispenser to apply water to a plurality of blocks.

FIG. 14 is a sectional perspective view of a lower housing member from the storage container shown in FIG. 11 with a divider thereon.

FIG. 15 is a perspective view of a block with some dimensions thereon.

FIG. 16 is a sectional elevation view of the storage container shown in FIG. 11.

### DETAILED DESCRIPTION OF EMBODIMENTS

Throughout the present disclosure, it will be understood that the term “an” to introduce an element is not intended to mean “one and only one” of that element. It is intended to mean “one or more” of that element, unless it would be obvious to one skilled in the art that more than one of the element would be unusable.

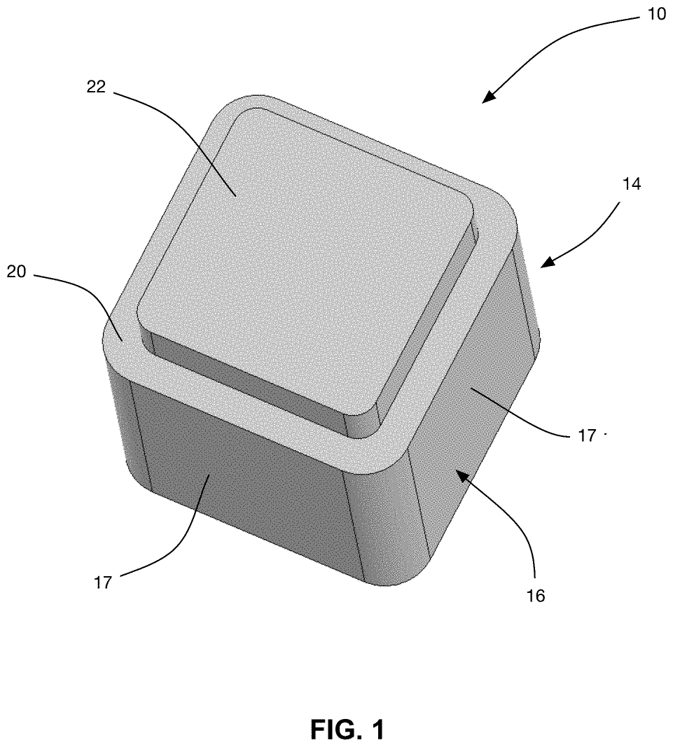

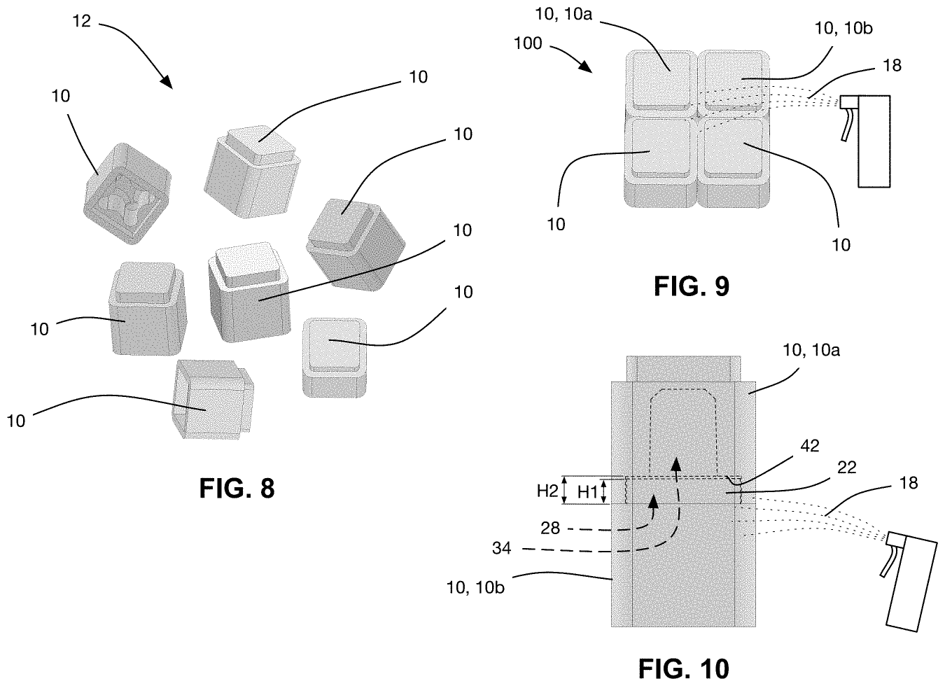

Reference is made to FIG. 1, which shows a block 10 in accordance with an embodiment of the present disclosure. The block 10 may be part of a kit for constructing a craft, wherein the kit is shown at 12 in FIG. 8. The kit 12 includes a plurality of the blocks 10. Seven blocks 10 are shown in FIG. 8, however, it will be understood that the kit 12 may include more or fewer of the blocks 10. In some cases there may be hundreds of the blocks 10 provided in the kit 12.

Each block 10 has a main body 14, which has an exterior surface 16 that is made from a material that is adherent when exposed to water so as to permit a first block (shown in FIG. 9, at 10a) from the plurality of blocks 10 to be adherable to a second block (shown at 10b) of the plurality of blocks 10 by applying water (shown at 18) to at least one of the first and second blocks. The material may become adherent, for example, by dissolving somewhat in the water 18, and then resolidifying once the water evaporates, thereby fusing blocks 10 that are adjacent one another when wetted. A suitable material may be, for example, polyvinyl alcohol (PVA). Any other suitable material may alternatively or additionally be used. The entire block 10 may be formed from the material, or alternatively may include a core from a first material, and an outer layer of the adherent material such as PVA.

The exterior surface 16 may include a plurality of generally planar (i.e. flat) exterior sidewalls 19 so as to promote surface-to-surface contact between adjacent blocks 10, thereby promoting adhesion therebetween. However, it is contemplated that any other suitable shape may be provided to the exterior surface 16.

Each block 10 further includes a top surface 20 and a block projection 22 extending from the top surface 20. The block projection 22 is shown as having a generally square shape, however, other shapes such as arcuate shape or other polygonal shapes or combinations thereof are contemplated. The block projection 22 has a height H1 (FIG. 10) from the top surface 20, which is described further below.

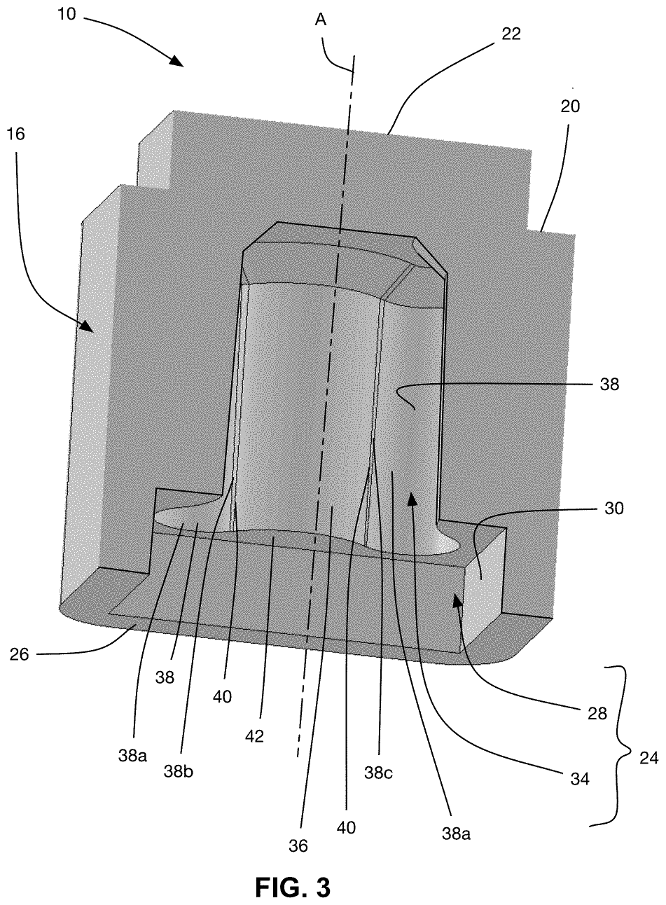

Each block 10 further including a bottom aperture 24 extending into the main body 14. The bottom aperture 24 may extend from a lowermost surface shown at 26, and my extend towards the top surface 20. The bottom aperture 24 may define a longitudinal axis A for the block 10 (FIG. 3).

The bottom aperture 24 includes a first aperture region 28. The first aperture region 28 is shaped to receive the block projection 22 of the second block 10b (FIG. 10) of the plurality of blocks 10.

The first aperture region 28 has a plurality of walls including a plurality of first region sidewalls 30 and a plurality of first region corners 32. The first region sidewalls 30 are connected to one another by the plurality of first region corners 32. Each first region corner 32 has a first average radius R1. The first average radius R1 is the average of the radii of all surfaces that make up the corner between two adjacent sidewalls 30 (not counting any flat surfaces). This average may be a weighted average based on the widths of the individual surfaces, or may be determined in any other suitable way. In the example shown, the first average radius R1 is small-less than 0.1 mm and may be considered approximately zero.

The bottom aperture 24 further includes a second aperture region 34 that extends into the main body 14 from the first aperture region 28. The second aperture region 34 has a plurality of second region sidewalls 36, which are connected to one another by a plurality of second region corners 38. Each second region corner 38 has a second average radius R2, may be determined using an analogous method to that which is used for determining the first average radius R1. The second average radius R2 is greater than the first average radius R1. In the example shown, a parting line between one of the second region sidewalls 36 and one of the second region corners 38 is shown at 40. In the example shown, the second average radius R2 is the weighted average radius of three surfaces shown at 38a, 38b and 38c. Given that the surface 38a is so much larger than the surfaces 38b and 38c, the second average radius will be relatively close to the radius of the surface 38a. It can be seen visually that the second average radius R2 is much larger than the first average radius R1.

The bottom aperture 24 includes a shoulder 42 between the first aperture region 28 and the second aperture region 34. The shoulder 42 defines a depth H2 (FIG. 10) of the first aperture region 28. As can be seen in FIG. 10, the depth H2 of the first aperture region 28 is greater than the height H1 of the block projection 22, such that the lowermost surface 26 of the first block 10a can contact the top surface 20 of the second block 10b, thereby facilitating their adherence together.

By providing the first aperture region 28 that is shaped to receive the block projection 22 of the second block 10b, and by providing the second aperture region 34 that has the second average radius R2 for the second region corners 38 that is larger than the first average radius R1, the second aperture region 34 provides added strength at the corners of the block 10 that would not be present if the entire bottom aperture 24 was shaped like the first aperture region 28.

Additionally, it can be seen that the second region sidewalls 36 progressively increase in thickness with increasing distance from the second region corners 38. This shape strengthens the second region sidewalls 36 against forces exerted thereon, while still conserving material used in the manufacture of the block 10. In other words, by providing the increase in thickness away from the second region corners 38, the material that makes up the block 10 is used where it is most needed to resist stresses that may be applied to it during use. This may also help the block 10 maintain its shape and inhibit warpage during manufacture, as compared to a block 10 where the entire bottom aperture 24 is like the first aperture region 28. In the example block 10 shown in the figures, the peak thickness of each second region sidewall 36 is centered between the second region corner 38 on either side of it.

In the example shown, the main body 14 of the block 10 has four corners, and the first aperture region 28 has four first region corners 32 and four first region sidewalls 30, and the second aperture region 34 has four second region corners 38 and four second region sidewalls 36. However, any other suitable number of corners and sidewalls may be used for each of the first and second aperture regions. Furthermore, the first and second aperture regions need not have the same number of corners as one other, and therefore need not have the same number of sidewalls as one another.

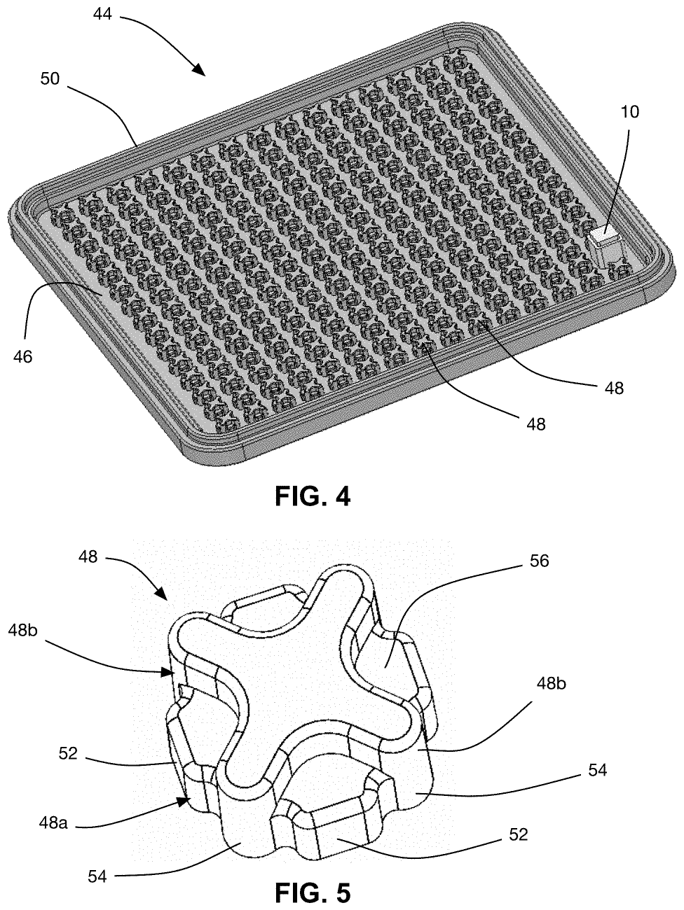

Referring to FIG. 4, the kit 12 may include a block tray 44 that is shaped to receive blocks 10 for assisting in creating a craft therewith. The block tray 44 includes a floor 46, a plurality of block tray projections 48 that extend upwards from the floor 46, and an edge wall 50 that surrounds the floor 44.

The block tray projections 48 are shaped to receive blocks 10 thereon and to position the blocks 10 so as to have the exterior surfaces 16 thereof be in contact with one another.

The floor 46 is provided to collect water that is sprayed onto the blocks 10 during the craftmaking process. The edge wall 50 is provided to prevent the water collected on the floor 46 of the block tray 44, from spilling off onto the table or other support surface on which the block tray 44 is positioned.

Magnified views of one of the block tray projections 48 are shown in FIGS. 5, 6, 7A and 7B. The block tray projection 48 may, in some embodiments, include a proximal portion 48a and a distal portion 48b. The first aperture region 28 of the bottom aperture 24 of each block 10 may be shaped to receive the proximal portion 48a of each block tray projection 48. In some embodiments, the proximal portion 48a includes a plurality of locating surfaces 52 that are engageable with the first region sidewalls 30 of the first aperture region 28 to securely position the block 10 in a selected position on the block tray 44. The proximal portion 48a further includes a plurality of air passage surfaces 54 that are positioned to be spaced from the block 10 when the block 10 is mounted thereon, to ensure that any water that inadvertently winds up in the bottom aperture 24 of the block 10 has a way of draining out.

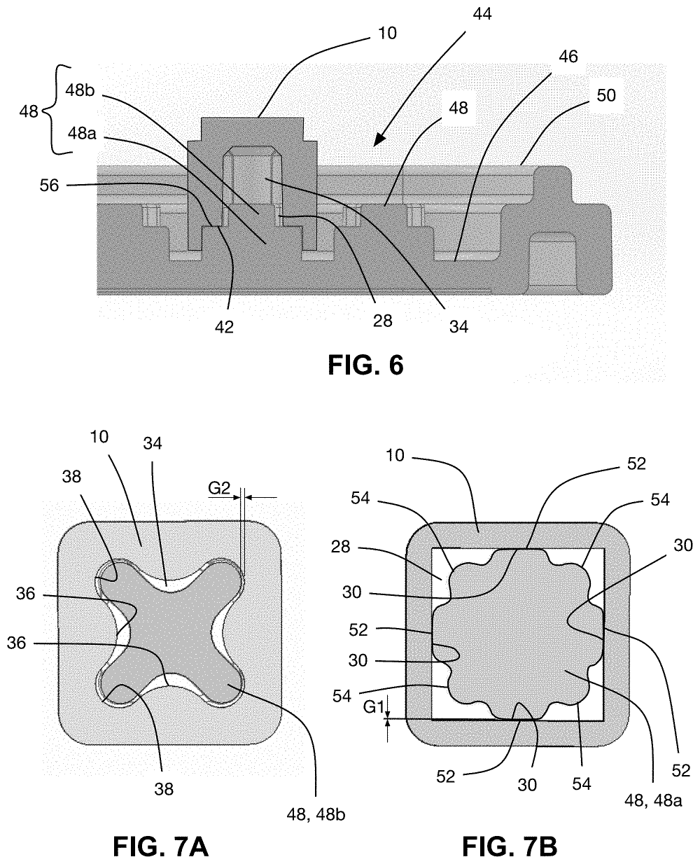

A limit surface 56 may be provided on the block tray projection 48. In the embodiment shown, the limit surface 56 is provided between the first portion 48a and the second portion 48b of the block tray projection 48. When the block 10 is positioned on the block tray projection 48, the limit surface 56 engages the shoulder 42 on the block 10. It may be said that the limit surface 56 is positioned in a selected position on the block tray 44 to hold the lowermost surface 26 of the block 10 above the floor 46 of the block tray 44 that surrounds the block tray projection 48, as can be seen in FIG. 6. As a result, the block 10 is essentially prevented from adhering to the floor 46. It may also be said that the depth H2 of the first aperture region 28 of the block 10 is selected such that the shoulder 42 is positioned to engage the limit surface 56 on the block tray 10 to hold the lowermost surface 26 of the block 10 above the floor 46 of the block tray 46 that surrounds the block tray projection 48.

The second aperture region 34 of the bottom aperture 24 of each block 10 may be shaped to receive the distal portion 48b of each block tray projection 48. Alternatively it may be said that the distal portion 48b of each block tray projection 48 may be shaped to receive the second aperture region 34 of the bottom aperture 24 of each block 10.

In some embodiments, the distal portion 48b may generally conform to the shape of the second aperture region 34 but may be spaced entirely from the walls of the second aperture region 34, so as to provide some increased stability to the block 10 resting thereon by inhibiting excessive tilting of the block 10 while the block 10 sits thereon, while also inhibiting the block 10 from adhering thereto in the event that any water is present therebetween, thereby facilitating removal of the block 10 therefrom once the craft is completed. Additionally, the spacing between the second portion 48b of the block try projection 48 and the walls of the second aperture region 34 facilitate water drainage in the event that there is any water on top of the block tray projection 48 or in the second aperture region 34 of the block 10 when the block 10 is mounted onto the block tray projection 48. As can be seen in FIG. 7B, there is a first minimum clearance G1 between the first aperture region 28 and the proximal portion 48a of the block tray projection 48. The first minimum clearance G1 is the clearance at the point where proximal portion 48a and the walls of the first aperture region 28 are closest to one another. This occurs in the example shown between any of the locating surfaces 52 and the first region side walls 30. The first minimum clearance G1 may be effectively zero in embodiments in which the locating surfaces 52 and the first region side walls 30 contact one another to when the block 10 is mounted to the block tray projection 48, as is the case in the example shown in FIG. 7B. Alternatively, the first minimum clearance G1 could be some other value, such as, for example 1 mm.

As can be seen in FIG. 7A, there is a second minimum clearance G2 between the second aperture region 34 and the distal portion 48b of the block tray projection 48. The second minimum clearance G2 is the clearance at the point where proximal portion 48b and the walls of the second aperture region 34 are closest to one another. The second minimum clearance G2 is larger than the first minimum clearance, which provides at least some of the advantages outlined above. In some embodiments, the second minimum clearance G2 may be in the range of 1-2 mm, in order to provide the advantages outlined above in relation to inhibiting adherence to the second portion 48b of the block tray projection 48 by the block 10. Based on the above, it may be said that the first aperture region 28 is sized to have a first minimum clearance G1 relative to the proximal portion 48a of the block tray projection 48, and the second aperture region 34 is sized to have a second minimum clearance G2 relative to the distal portion 48b of the block tray projection 48, wherein the first minimum clearance G1 is smaller than the second minimum clearance G2.

An example of a simple craft is shown at 100 in FIG. 9, which is formed from four blocks 10 that are adhered together.

While it has been shown for the kit 12 to optionally include the block tray 44 shown in FIG. 4, it will be understood that the kit 12 might not include the block tray 44, but may include a plurality of blocks 10 that are shaped, in at least some embodiments, to be received on a pre-existing block tray 44, as described herein.

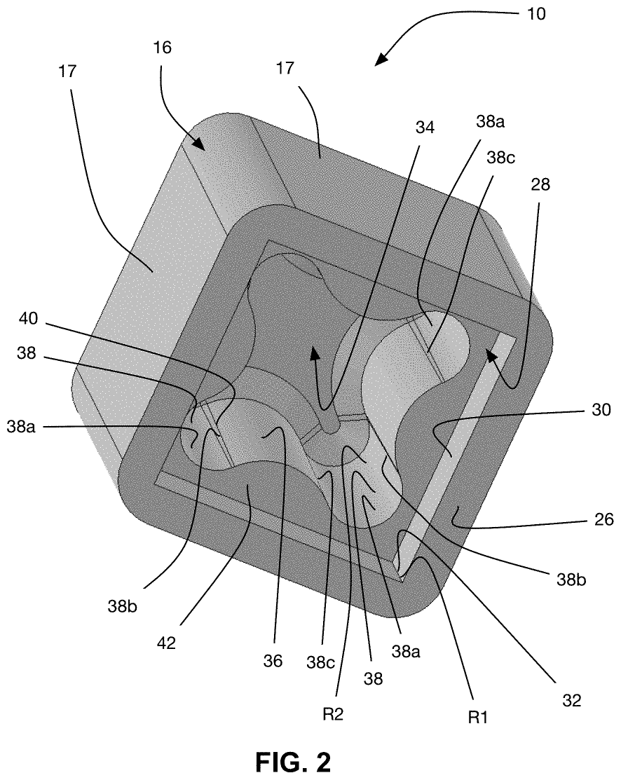

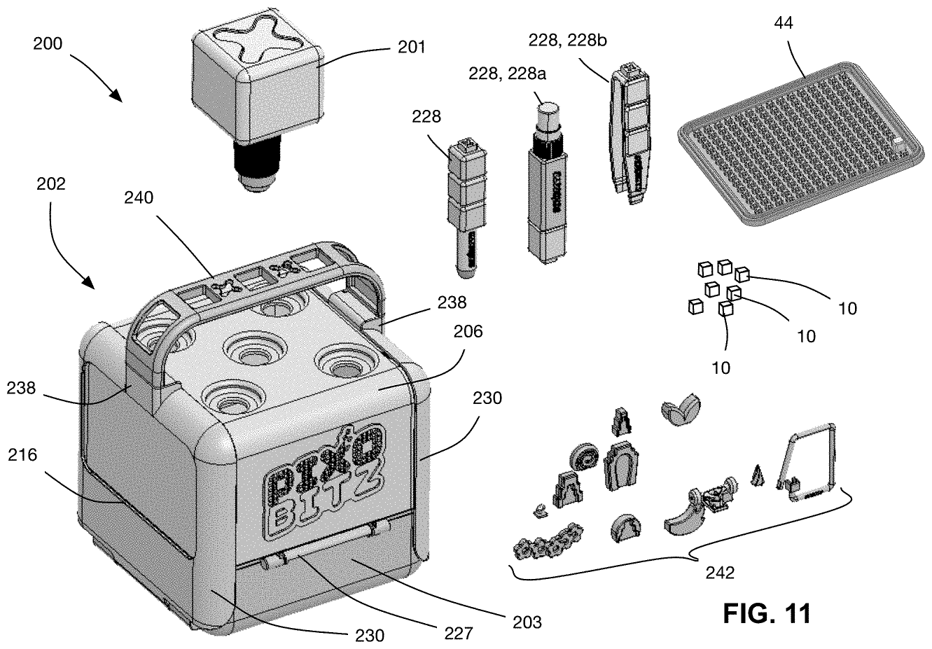

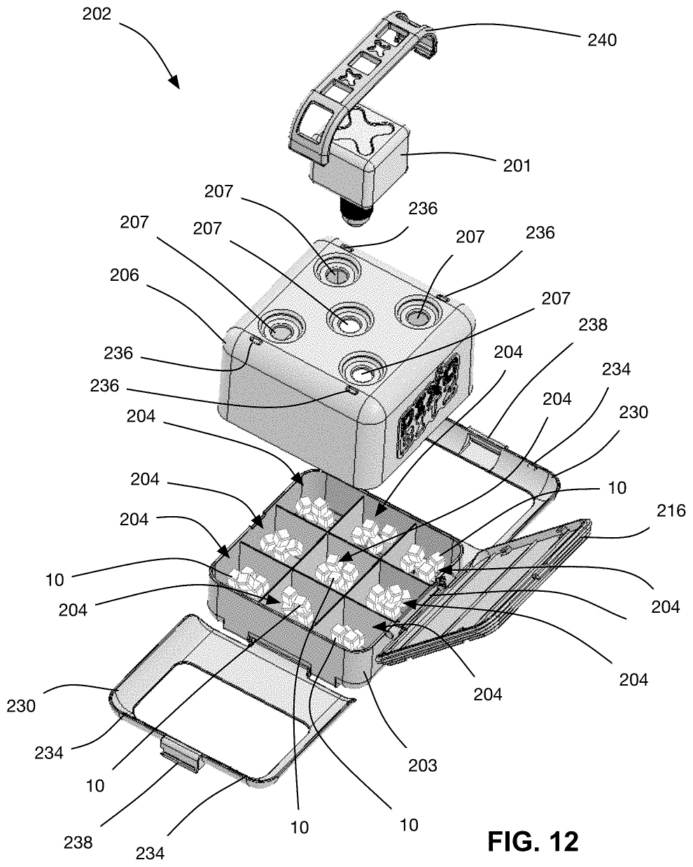

Reference is made to FIG. 11, which shows a kit 200 for use in constructing a craft from a plurality of blocks 10. For this aspect of the disclosure it is not critical for the blocks 10 to be identical to the blocks 10 shown in FIG. 1. For this aspect of the disclosure, each block 10 has a main body 14 having an exterior surface 16 that is made from a material that is adherent when exposed to water 18 so as to permit a first block 10a from the plurality of blocks 10 to be adherable to a second block 10b of the plurality of blocks by applying water to at least one of the first and second blocks 10a and 10b. It is not necessary however, for each block 10 to include a bottom aperture (although they can) or for each block 10 to include a top projection (although they can). Other features on the block 10 shown in FIGS. 1 and 2 need not be present in the block 10 shown in FIG. 12. Furthermore, some blocks 10 are shown in FIG. 11. It will be noted that the kit 200 may include the plurality of blocks 10 but need not include them. The kit 200 should be configured to be used with the blocks 10, however. Similarly, the kit 200 may optionally include the block tray 44. However, the block tray 44 need not be identical to the block tray 44 shown in FIG. 4. The block tray 44 for this aspect of the disclosure need not, for example, include block tray projections 48. However, the kit 200 may optionally not include the block tray 44. However, the kit 200 should be configured to be used with the block tray 44 however.

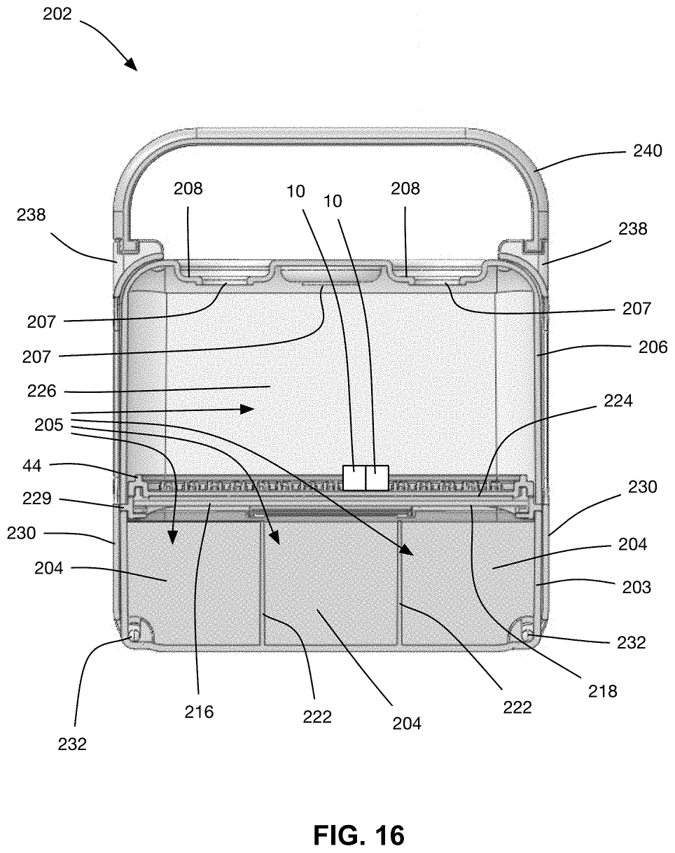

The kit 200 includes a water dispenser 201 for dispensing water 18, and a storage container 202. The storage container 202 includes a lower housing member 203 that contains at least one block storage compartment 204 for holding the plurality of blocks 10, and a cover 206 that is sized to mount at least indirectly to the lower housing member 203 to form an enclosed storage container interior 205 (FIG. 16) therewith. In the embodiment shown, the at least one block storage compartment 204 includes nine block storage compartments 204 as shown in FIG. 12. Each block storage compartment 204 may be used to hold blocks 10 of a different color or shape, as desired by the user. While nine block storage compartments 204 are shown, it will be understood that the storage container 200 may container fewer or more block storage compartments 204.

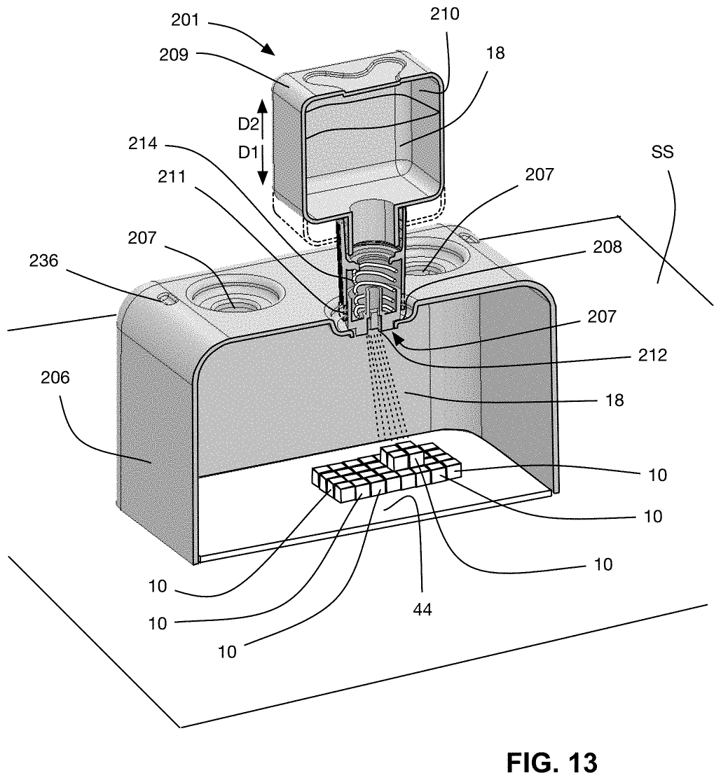

The cover 206 is openable to permit access to the storage container interior 205 and is sized to fit over the block tray 44 while the block tray 44 holds at least some of the plurality of blocks 10. The cover 206 is shown fitting over the block tray 44 while the block tray 44 rests on a support surface SS such as a table in FIG. 13. The cover 206 is shown fitting over the block tray 44 while the block tray 44 rests on a divider 216 that is part of the storage container 202 in FIG. 16.

The cover 206 has an opening 207 thereon, which is described further below. In the embodiment shown, the cover 206 has a plurality of openings 207 however, in embodiments where the cover 206 includes any openings 207, there could be as few as one opening 207, or two or more openings 207, depending on the application. For each opening 207, the cover 206 includes a support surface 208 adjacent the opening 207.

In the embodiment shown, the water dispenser 201 includes a storage section 209 that has a water storage chamber 210 therein, and a water outlet section 211 that has a water outlet 212. The storage section 209 is movable relative to the outlet section 211. When the water dispenser 201 is inverted into the dispensing position shown in FIG. 13, the storage section 209 is movable in a first direction (shown by arrow D1 in FIG. 13) relative to the outlet section 211 to bring the water dispenser 201 to a compressed position (wherein the position of the storage section 209 in this state is shown in dashed lines in FIG. 13), so as to push water 18 contained in the water dispenser 201 out from the water outlet 212, onto the plurality of blocks 10 on the block tray 44. The storage section 209 is also movable in a second direction (shown by arrow D2 in FIG. 13) relative to the outlet section 211 to bring the water dispenser 201 to an extended position (wherein the position of the storage section 209 in this state is shown in solid lines in FIG. 13), so as to draw air into the water storage chamber 210 to ready the water dispenser 201 to move to the compressed state again to dispense more water 18.

In some embodiments, the water dispenser 201 further includes a water dispenser biasing member 214 that is positioned to urge the storage section 209 and the outlet section 211 away from one another so as to urge the water dispenser 201 towards the extended state. In the embodiment shown, the water dispenser biasing member 214 is a helical compression spring, however, any other suitable type of biasing member may be used.

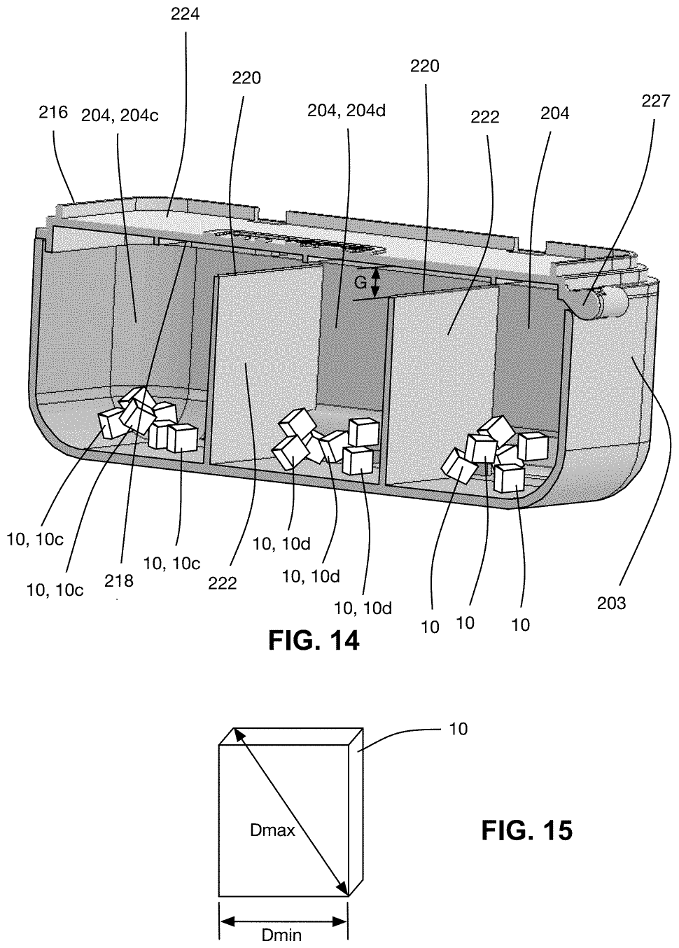

In some embodiments the storage container 201 further includes the optionally provided divider 216. The divider 216 is positioned to enclose each of the plurality of block storage compartments 204 so as to inhibit spillage and mixing of any blocks 10 from the plurality of blocks 10 stored in any one of the plurality of block storage compartments 204 with any blocks 10 from the plurality of blocks 10 stored in any other one of the plurality of block storage compartments 204. For example, as shown in the sectional view shown in FIG. 14, the blocks shown at 10c, which are stored in the block storage compartment shown at 204c are inhibited from mixing with the blocks shown at 10d, which are stored in the block storage compartment shown at 204d because of the presence of the divider 216, in the event that the storage container 201 is overturned or shaken violently or bumped hard. In some embodiments, the underside, shown at 218, of the divider 216 is positioned sufficiently close to an upper edge shown at 220, of the block storage compartment walls, shown at 222, that the blocks 10 in the block storage compartments 204 are prevented completely from mixing with one another. To accomplish this, the gap between the upper edges 220 of the block storage compartment walls 222 (shown at G in FIG. 14) would be smaller than the minimum dimension of the blocks 10 (shown at Dmin in FIG. 15). The minimum dimension of the blocks 10 is the smallest dimension of all their dimensions, which determines what size gap they would fit through. In the case of a block 10 that has a square base and which is taller than either of the base dimensions (as is the case in the example shown in FIG. 15), the minimum dimension is either of the width or depth of the base.

However, in other embodiments, the underside 218 of the divider 216 is positioned sufficiently close to the upper edges 220 of the block storage compartment walls 222 so as to inhibit mixing of the different types of blocks 10 with one another, but not so close as to completely prevent mixing of the different types of blocks 10 with one another. To accomplish this, the gap G between the upper edges 220 of the block storage compartment walls 222 would be smaller than the maximum dimension of the blocks 10 (shown at Dmax in FIG. 15). The maximum dimension of the blocks 10 is the largest dimension of all their dimensions, which determines what size gap would offer resistance to the pass-through of a block 10 oriented in the least optimized way to pass through such a gap. In the case of the block 10 shown in FIG. 15, the maximum dimension is the dimension from a corner at the top of the block 10 to an opposing corner at the base of the block 10. As can be seen, the maximum dimension Dmax for the block 10 is larger than the minimum dimension Dmin. By sizing the gap G to be at least smaller than the maximum dimension Dmax of the blocks 10, it may be said that the divider 216 is positioned sufficiently close to the upper edges 220 of the block storage compartment walls 222 so as to at least inhibit spillage and mixing of any blocks 10 from the plurality of blocks 10 stored in any one of the plurality of block storage compartments 204 with any blocks 10 from the plurality of blocks 10 stored in any other one of the plurality of block storage compartments 204.

Referring to FIG. 16, the divider 216 includes an upper surface 224 that defines a floor of a secondary storage compartment 226 for the storage container 202. The secondary storage compartment 226 is sized to hold additional items. For example, in the embodiment shown, the secondary storage compartment 226 is sized to hold the block tray 44 therein. Additionally or alternatively the secondary storage compartment 226 may be sized to hold other items including, for example, one or more craft-making tools shown at 228 (FIG. 11).

The divider 216 may be hingedly mounted by a divider hinge 227, to the lower housing member 203 as shown in the figures and may have a lip 229 that supports the perimeter of the divider 216 on the lower housing member 203. The divider 216 may alternatively be completely removable from the lower housing member 203 instead of being connected thereto by a divider hinge.

The cover 206 encloses the secondary storage compartment 226 when connected at least indirectly to the lower housing member 203. In the embodiment shown, the cover 206 may mount directly onto the divider 216.

The craft-making tools 228 may include any suitable tools, such as, for example, a small water-sprayer shown at 228a that can be used to spray a relatively small amount of water in a localized area of a craft being made, and a block tweezer for picking up individual blocks 10.

The cover 206 in the embodiment shown is openable by being completely removable from the rest of the storage container 202. In order to hold the cover 206 in place when it is mounted (at least indirectly to the lower housing member 203), a pair of latch members 230 may be provided. The latch members 230 may each be hinged to one of the cover 206 and the lower housing member 203, and may releasably latch to the other of the cover 206 and the lower housing member 203. In the embodiment shown, the latch members 230 are both hinged to the lower housing member 203, at latch member hinges 232, and latch to the cover 206 at a latch structure which may be provided by a pair of small projections 234 (FIG. 12) on each latch member 230 that resiliently engage a pair of small depressions 236 on the cover 206. The latch members 230 may further include mounts 238 for receiving a handle 240 for carrying the storage container 202. The handle 240 may be releasable from one or both of the latch members 230 so as so to permit their separation from the cover 206 so as to permit the user to open the storage container 202.

While latch members 230 are shown as being used to hold the cover 206 onto the rest of the storage container 202, any other suitable locking structure could alternatively be used.

While the cover 206 has been shown as being completely removable from the rest of the storage container 202, it is alternatively possible for the cover 206 to be hingedly connected to the lower housing member 203 or to some other part of the storage container 202, and to be openable by pivoting towards an open position. One or both of the latch members 230 could be provided in such an embodiment.

Referring to FIG. 11, additional elements that may be included in the kit 200 (and/or in the kit 12) include accessories shown at 242, which may be made from the same material as the blocks 10 and which may therefore also be adherable to the blocks 10 and/or to one another by applying water to them.

While the dispensing of water 18 onto the blocks 10 using the cover 206 to cover the block tray 44 is illustrated with the block tray 44 sitting on the support surface SS that is a table (FIG. 13), it will be understood that this could be done while the block tray 44 sits on the divider 216 in the storage container 202. For example, in FIG. 16, the handle 240 would be removed and the water dispenser 201 could be inserted into one of the openings 207 to dispense water 18 onto the blocks 10 held on the block tray 44.

The above-described embodiments are intended to be examples of the present invention and alterations and modifications may be effected thereto, by those of skill in the art, without departing from the scope of the invention that is defined solely by the claims appended hereto.

What is claimed is:

1. A kit for use in constructing a craft from a plurality of blocks and a block tray, each block having a main body having an exterior surface that is made from a material that is adherent when exposed to water so as to permit a first block from the plurality of blocks to be adherable to a second block of the plurality of blocks by applying water to at least one of the first and second blocks, the block tray being shaped to support the plurality of blocks, the kit comprising:
a water dispenser for dispensing water; and
a storage container including a lower housing member that contains at least one block storage compartment for holding the plurality of blocks, and a cover that is sized to mount at least indirectly to the lower housing member to form an enclosed storage container interior therewith, wherein the cover is openable to permit access to the storage container interior, and is sized to fit over the block tray while the block tray holds the plurality of blocks, wherein the cover further includes an opening that is sized to permit, during use, a user to dispense water onto the plurality of blocks on the block tray.

2. The kit as claimed in claim 1, wherein the water dispenser includes a storage section with a water storage chamber for holding a volume of water, and an outlet section with a water outlet, wherein the cover has a support surface for engagement with the outlet section adjacent the opening with the water outlet positioned at the opening,
wherein the storage section is movable in a first direction relative to the outlet section to bring the water dispenser to a compressed state while the outlet section is engaged with the support surface, so as to push water 18 contained in the water dispenser out from the water outlet onto the plurality of blocks on the block tray, and is movable in a second direction relative to the outlet section to bring the water dispenser to an extended state so as to draw air into the water storage chamber.

3. The kit as claimed in claim 1, wherein the water dispenser includes a water dispenser biasing member that is positioned to urge the storage section and the outlet section away from one another so as to urge the water dispenser towards the extended state.

4. The kit as claimed in claim 1, wherein the at least one opening is a plurality of openings that are spaced from one another so as to permit the user to dispense water over different regions of the block tray.

5. The kit as claimed in claim 1, wherein the at least one block storage compartment is a plurality of block storage compartments, which are defined by a plurality of block storage compartment walls which have upper edges, and wherein the storage container further includes a divider that is positioned sufficiently close to the upper edges to at least inhibit spillage and mixing of any blocks from the plurality of blocks stored in any one of the plurality of block storage compartments with any blocks from the plurality of blocks stored in any other one of the plurality of block storage compartments.

6. The kit as claimed in claim 5, wherein the divider includes an upper surface that defines a floor of a secondary storage compartment for the storage container, wherein the secondary storage compartment is sized to hold the block tray therein, and wherein the cover encloses the secondary storage compartment when connected at least indirectly to the lower housing member.

7. A storage container for use in constructing a craft from a plurality of blocks, each block having a main body having an exterior surface that is made from a material that is adherent when exposed to water so as to permit a first block from the plurality of blocks to be adherable to a second block of the plurality of blocks by applying water to at least one of the first and second blocks, wherein each block has a minimum dimension and a maximum dimension that is larger than the minimum dimension, the storage container comprising:
a lower housing member that contains a plurality of block storage compartments for holding the plurality of blocks, wherein the block storage compartments are defined by a plurality of block storage compartment walls which have an upper edge;
a divider that is positioned such that a gap between the upper edge of the block storage compartment walls and an underside of the divider is smaller than the maximum dimension of each of the plurality of blocks so as to at least inhibit spillage and mixing of any blocks from the plurality of blocks stored in any one of the plurality of block storage compartments with any blocks from the plurality of blocks stored in any other one of the plurality of block storage compartments, wherein the divider has an upper surface that is a floor of a secondary storage compartment for the storage container; and
a cover that is sized to mount at least indirectly to the lower housing member to form an enclosed storage container interior therewith, wherein the cover is cover is openable to permit access to the storage container interior, and is sized to fit over the block tray while the block tray holds the plurality of blocks, wherein the cover encloses the secondary storage compartment when connected at least indirectly to the lower housing member.

8. The storage container as claimed in claim 7, wherein the secondary storage compartment is sized to hold the block tray therein.
